(19) United States
(12) Patent Application Publication
(10) Pub. No.: US 2025/0208032 A1
(43) Pub. Date: Jun. 26, 2025

(54) SYSTEM AND METHOD FOR DETERMINING ONE OR MORE PROPERTIES OF AN OBJECT

(71) Applicant: Northeastern University, Boston, MA (US)

(72) Inventors: Kristen Dorsey, Roslindale, MA (US); Nathaniel Hanson, Boston, MA (US); Taskin Padir, Westborough, MA (US); Charles DiMarzio, Cambridge, MA (US); Natalie Daly, Boston, MA (US); Austin Nilo Allison, Boston, MA (US)

(21) Appl. No.: 18/990,171

(22) Filed: Dec. 20, 2024

Related U.S. Application Data
(60) Provisional application No. 63/613,570, filed on Dec. 21, 2023.

(51) Int. Cl. G01N 21/27; G01B 11/255; G01N 21/25

(52) U.S. Cl. CPC G01N 21/274; G01B 11/255; G01N 21/255; G01N 2201/084; G01N 2201/12761

(57) ABSTRACT

Systems and methods for determining properties of an object are disclosed. A system includes a gripping element and at least one waveguide coupled to the gripping element. The waveguide is configured to transport a light signal through the gripping element and to transmit the light signal, at least a portion of the light signal illuminating the object. A detector is configured to detect at least a portion of the light signal and sense a curvature of the gripping element. A probe element coupled to the gripping element is configured to collect light reflected from the object. A spectrometer is configured to generate spectral data using the reflected light collected. A processor is configured to calibrate the spectral data based on the curvature and to determine properties of the object based on the curvature and the spectral data. The system enables recognition and profiling of objects based on spectroscopy and curvature.

### RELATED APPLICATION(S)

This application claims the benefit of U.S. Provisional Application No. 63/613,570, filed on Dec. 21, 2023. The entire teachings of the above application are incorporated herein by reference.

### BACKGROUND

Soft actuators and robots may provide flexibility, adaptability, and compliance for robotic systems to operate in a breadth of environments, including for tasks that are oriented toward delicate manipulation or safe operation. Quickly recognizing and accepting an object or a human using a soft actuator or robot may require significant information about the object's characteristics, including, without limitation, size, shape, texture, position, or center of mass. While integrating sensors may provide some of this information, the actuation and bending of soft actuators and robot present additional challenges toward system longevity and fatigue-induced failures. Developing soft actuators and robots with robust sensing capabilities for a breadth of characteristics, including spectral information, size, and shape, may enable greater autonomy of soft actuators and robots and increased adoption of robotic and automated systems in a range of applications.

### SUMMARY

According to an example embodiment of a system for determining one or more properties of an object, the system may comprise a gripping element configured to bend with respect to an axis and at least one waveguide operatively coupled with the gripping element. The waveguide may be configured to transport a light signal from a light source through at least a portion of the gripping element and to transmit the light signal transported. At least a portion of the light signal transmitted may illuminate the object. The system may further comprise a detector configured to detect at least a portion of the light signal transmitted and to sense a curvature or a change in curvature of the gripping element with respect to the axis based on the light signal detected. The system may further comprise a probe element operatively coupled with the gripping element, and the probe element may include a probe waveguide configured to collect reflected light from the object. The system may further comprise a spectrometer optically coupled to the probe element and configured to generate spectral data based on the reflected light collected. The system may further comprise a processor communicatively coupled to the detector and the spectrometer. The processor may be configured to apply a calibration factor to the spectral data generated based on the curvature or the change in curvature sensed to produce calibrated spectral data and to determine one or more properties of the object based on the curvature or the changed in curvature sensed, the calibrated spectral data, or a combination thereof.

The at least one waveguide may be configured to enable a change in a characteristic of the light signal transported based on a bending of the waveguide. The characteristic of the light signal may be an intensity of the light signal, and the detector may be configured to sense the curvature, or the change in curvature, of the gripping element based on a change in the intensity of the light signal detected.

The waveguide and the probe waveguide may include a polymer core and a polymer cladding. The polymer core may be composed of polymethyl methacrylate, urethane rubber, or other polymer, and the polymer cladding may be composed of fluorinated polymer or other polymer.

The light source may illuminate at a single wavelength or a plurality of wavelengths.

The at least one waveguide may include at least two waveguides: a first waveguide of the at least two waveguides configured to illuminate the object, and at least one second waveguide of the at least two waveguides configured to transport the light signal from the light source and to transmit the light signal transported to the detector. The system may further comprise a plurality of light sources, the at least one waveguide including a respective waveguide configured to transport the light signal from a corresponding respective light source and to transmit the light signal transported. The spectral characteristics of the plurality of light sources may be different and may include: a first light source with a first spectral characteristic configured to illuminate the object, and at least one second light source with a second spectral characteristic configured to transmit light signal through a corresponding respective waveguide to the detector.

The detector may be configured to detect the light signal transported at a single wavelength or a plurality of wavelengths. The detector may be further configured to sense the curvature, or the change in curvature, of the gripping element based on the light signal detected at a single wavelength or at least one sub-band of the plurality of wavelengths.

The properties of the object may include a curvature, or change in curvature, size, shape, color, composition, quality, class, material, content, texture, a chemical property, or a physical property.

The gripping element may include an elastomeric pad that is arranged to come into contact with the object, and wherein the waveguides are in coupled arrangement with the elastomeric pad. The gripping element may be configured to bend along multiple directions with respect to the axis. The gripping element may also be a first gripping element, and the system may include at least one second gripping element. The first gripping element, the at least one second gripping element, or a combination thereof may be configured to grasp the object and to determine the one or more properties of the object.

The processor may be configured to determine the one or more properties of the object by comparing the curvature sensed, the calibrated spectral data, or a combination thereof by comparing against a database of curvatures, spectral signatures, or a combination thereof or by using a machine learning model or an inference model.

According to another example embodiment, a method for determining one or more properties of the object may comprise transporting light signal through at least a portion of a gripping element configured to bend with respect to an axis. The method may further comprise sensing a curvature or a change in curvature of the gripping element with respect to the axis based on the light signal transported. The method may still further comprise illuminating the object, collecting reflected light from the object, and generating spectral data based on the reflected light collected and calibrating the spectral data based on the curvature or the change in curvature with respect to the axis sensed. The method may further comprise determining the one or more properties of the object based on the calibrated spectral data, the curvature sensed, or a combination thereof.

Transporting the light signal through at least a portion of the gripping element may change a characteristic of the light signal transported based on a state of the gripping element.

Determining the one or more properties of the object based on the calibrated spectral data, the curvature sensed, or a combination thereof may include using a machine learning model or an inference model.

The method may further comprise acquiring a set of reference properties for the objected through use of the gripping element and storing the set of reference properties acquired. The method may still further comprise grading additional objects of a similar type to the object through use of the gripping element based on the reference properties stored. Acquiring the set of reference properties for the object may further include acquiring reference properties over a substantially full range of bending with respect to the axis of the gripping element through use of objects of a similar type over a range of sizes.

According to another example embodiment, a system for determining one or more properties of an object may comprise means for sensing a curvature or change in curvature of a gripping element configured to bend along at least one direction with respect to an axis based on a change in a property of a light signal, the light signal transported through at least a portion of the gripping element. The system may further comprise means for generating spectral data of the object based on light reflected from the object, the light reflected coming from a known source, and for calibrating the spectral data generated based on the curvature or change in curvature sensed. The system may still further comprise determining one or more properties of the object based on the curvature or change in curvature sensed, the calibrated spectral data, or a combination thereof.

According to another example embodiment, a gripper for determining one or more properties of an object comprises a gripping element configured to bend with respect to an axis and at least one waveguide operatively coupled to the gripping element. The at least one waveguide is configured to enable the coupling of a light signal at a first terminus and to transport at least a portion of the light signal coupled through a length of the waveguide, the length of the waveguide traversing at least a portion of the gripping element. The at least one waveguide is further configured to transmit the light signal transported at a second terminus and to illuminate the object with at least a portion of the light signal transmitted. The gripper further comprises a probe element, operatively coupled to the gripper. The probe element includes a probe waveguide. The probe waveguide includes a collection terminus configured to collect reflected light from the object at a point on the gripping element and an output terminus configured to output the reflected light collected. The probe waveguide may be further configured to carry the reflected light collected from the collection terminus to the output terminus.

In some embodiments, the at least one waveguide includes at least two waveguides. In one example embodiment, a first waveguide of the at least two waveguides is configured to illuminate the object, and at least one second waveguide of the at least two waveguides is configured to transport light from the light source and to transmit the light transported to the detector.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is an illustration of an example embodiment of a system for determining one or more properties of an object.

FIG. 2 is an exploded diagram of an example embodiment of a gripper of a system for determining one or more properties of an object.

FIG. 3 is a cross-sectional illustration of a gripping element of an example embodiment of a system for determining one or more properties of an object.

FIG. 4 is a plot of example measurements of transmittance of light of different wavelengths through waveguides composed of different material types.

FIG. 5A is a surface plot of example measurements of light transmittance of different wavelengths through waveguides composed of polymethyl methylacrylate (PMMA) of different lengths.

FIG. 5B is a surface plot of example measurements of insertion loss of light of different wavelengths through waveguides composed of PMMA of different lengths.

FIG. 5C is a plot of example measurements of insertion loss versus waveguide length at specific wavelengths representing points of strong absorption and reflection as determined by FIG. 5B.

FIG. 6 is a stepwise illustration of an example fabrication process for a gripper for determining one or more properties of an object.

FIG. 7 is an exploded diagram of an example embodiment of a system for determining one or more properties of an object.

FIG. 8 is a flow diagram of an example method for determining one or more properties of an object.

FIG. 9A is an illustration of an example experiment to characterize optical transmission as a function of curvature of a system for determining one or more properties of an object.

FIG. 9B is an illustration of example configurations of the system of FIG. 9A in different bending configurations as captured by a motion sensor.

FIG. 9C is a plot of example measurements of light transmission across a spectral range for the system of FIG. 9A in an unactuated state and an actuated state.

FIGS. 10A-10D are plots of example measurements of curvature measured by a motion sensor and curvature measured by an optical waveguide at different wavelengths for a system for determining one or more properties of an object.

FIG. 11 is an illustration of an example embodiment of a system for determining one or more properties of an object, the system grasping an object.

FIG. 12 is a plot of example spectral measurements of a system for determining one or more properties of an object in unactuated and actuated bending configurations, along with spectral data calibrated based upon measurements of a curvature of the system.

FIG. 13A is a plot of example spectral measurements using a system for determining one or more properties of an object on a selection of household items.

FIG. 13B is a plot of dissimilarities between the spectral measurements of the selection of household items of FIG. 13A.

### DETAILED DESCRIPTION

A description of example embodiments follows.

Soft actuators and robots may be useful in applications involving human interaction and collaboration, delicate manipulation, and morphing structures. Further, in situations where humans interact with robots in unstructured environments, using soft or mechanically compliant materials may significantly improve safety. The continuum deformation and compliance of materials (e.g., rubber, textile) used in soft robots make them compelling selections for these applications.

Designing a soft actuator to manipulate a fragile object, to accept an object from a human quickly, or to classify a hand-held object requires a significant amount of information about an actuator's deformation and the object's texture, shape, position, size, or center of mass, among other characteristics. Sensors embedded within or external to a manipulator can deliver a fraction of this information, but distinguishing between objects with similar sizes, appearances, or mechanical properties may complicate this challenge. Bending of soft actuators may further affect the accuracy of sensor measurements. Developing soft sensors capable of performing spectroscopic analysis, measuring curvature or shape, and calibrating sensor measurements based on the curvature measured may enhance the utility of soft actuators and increase the adoption thereof.

In addition to the described challenges for soft actuators and robots, repeat actuation cycles of the soft actuator or robot may be detrimental to materials embedded in the soft gripper, for example, flexible circuit boards, and the materials embedded may be subject to fatigue or failure. Moreover, embedded components, including the flexible circuit board and, for example, light sources and optics components for acquiring spectral information, are not easily replaceable.

Described herein is a system (a Simultaneous Curvature and Near Infrared Sensing, or SCANS, system or sensor) including a soft gripper configured to acquire spectral signatures of grasped objects, integrating advances in soft optical sensing and robot-centric spectroscopy for a high-throughput, multi-functional sensor. Features of the system include a design for a multi-functional gripper for acquiring in-hand spectral signatures with an electronics free sensor and a methodology to correct for attenuation of spectral signals induced by a curvature or change in curvature of the sensor.

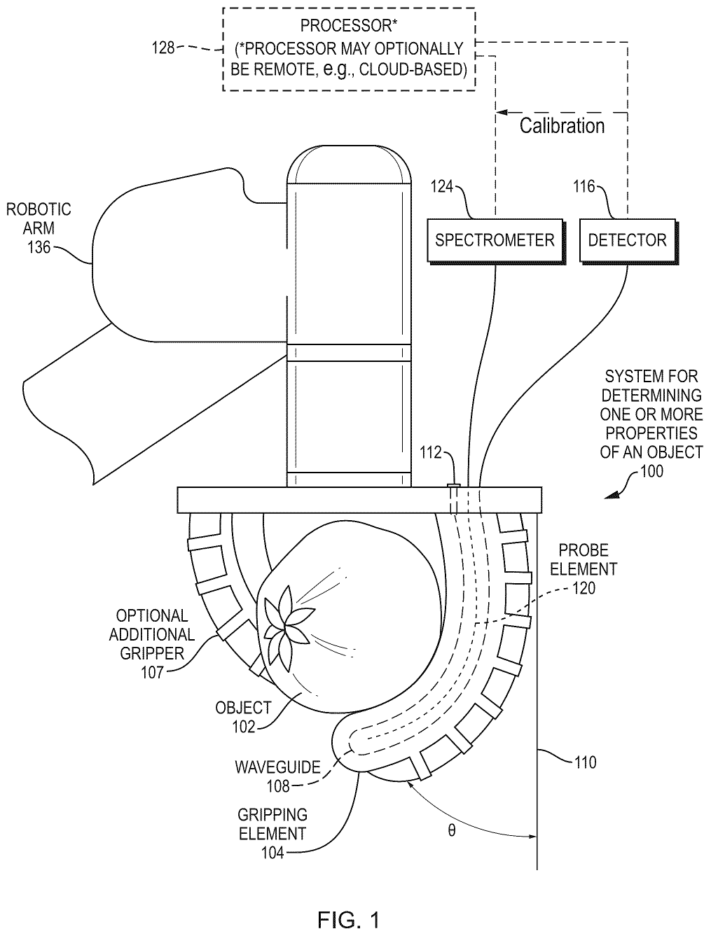

FIG. 1 is an illustration of an example embodiment of a system 100 for determining one or more properties of an object 102. The system 100 comprises a gripping element 104 configured to bend with respect to an axis 110. Bending of the gripping element 104 at an angle θ with respect to the axis 110 may enable grasping of the object 102. The system 100 further comprises at least one waveguide 108 operatively coupled with the gripping element 104, the waveguide 108 configured to transport a light signal from a light source 112 through at least a portion of the gripping element 104. The light source 112 may emit light at a single wavelength or at a plurality of wavelengths. The at least one waveguide 108 is further configured to transmit the light signal transported, of which at least a portion of the light signal transmitted illuminates the object 102. The system 100 further comprises a detector 116 configured to detect at least a portion of the light signal transmitted by the waveguide 108 and to sense a curvature or a change in curvature of the gripping element 104 with respect to the axis 110 based on the light signal detected.

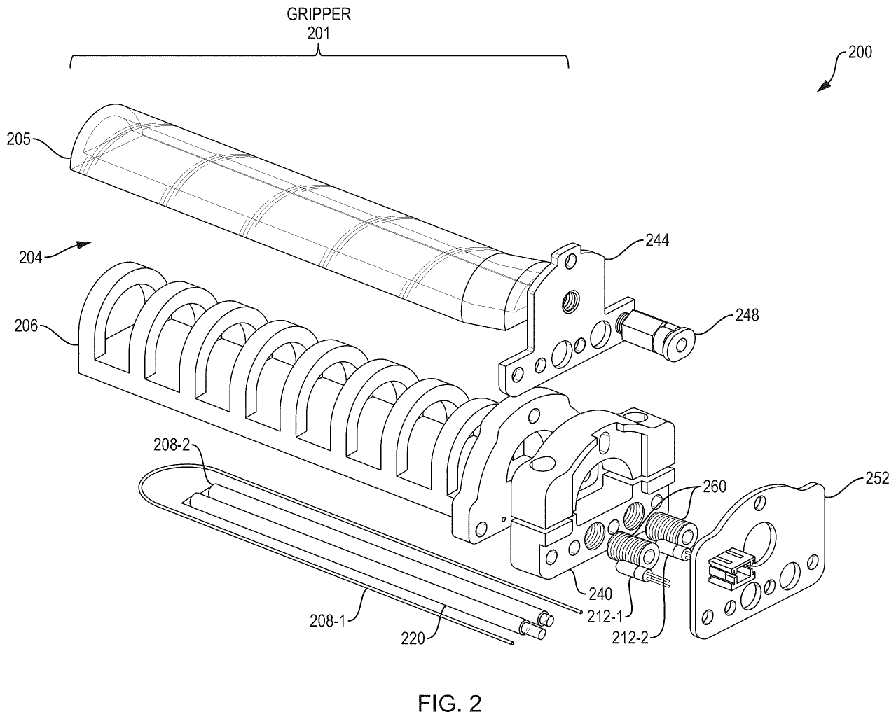

Additionally, the example embodiment of the system comprises a probe element 120 operatively coupled with the gripping element 104. The probe element may include a probe waveguide, similar with respect to the probe waveguide 221 of FIG. 2. The probe waveguide is configured to collect reflected light from the object 102. The system 100 further comprises a spectrometer 124 optically coupled to the probe element 120 and configured to generate spectral data based on the reflected light collected.

The system 100 further comprises a processor 128 communicatively coupled to the detector 116 and to the spectrometer 124. The processor 128 is configured to apply a calibration factor to the spectral data generated based on the curvature or the change in curvature sensed to produce calibrated spectral data. The processor 128 is further configured to determine one or more properties of the object 102 based on the curvature or the change in curvature sensed, the calibrated spectral data, or a combination thereof. The processor 128 may optionally be a remote processor, for example, a cloud-based processor.

Optionally, the system 100 may be deployed as part of a robotic system, for example, as an end effector of a robotic arm 136. The gripping element may be a mechanical gripper or a robotic gripper, for example, a soft-actuated finger. The gripping element may include hinges and rigid components or may include a soft gripper. The soft gripper may be configured to bend continuously along a length with respect to the axis 110. Optionally, the system 100 may include at least one additional gripper 107. The at least one additional gripper 107 may be similar to the gripping element 104.

FIG. 2 is an exploded diagram of an example embodiment of a system 200 for determining one or more properties of an object. The system 200 may be similar to the system 100 and comprises a gripping element 204 configured to bend with respect to an axis. In some embodiments, the gripping element 204 may be a soft robot and includes an inflatable bladder 205 and an exoskeleton 206. The exoskeleton 206 may be composed of a polymer or elastomer, for example, thermoplastic polyurethane.

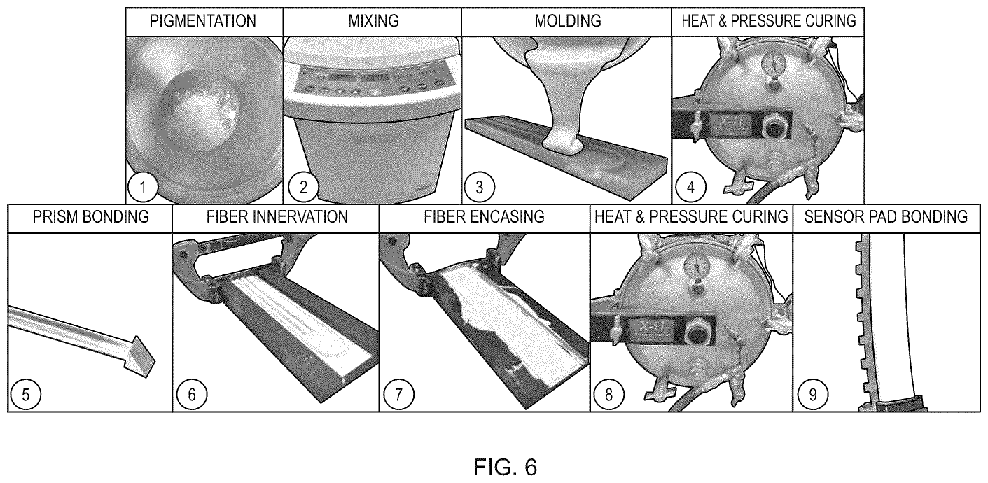

The system 200 further comprises at least one waveguide 208-1, 208-2 operatively coupled with the gripping element 204. In some embodiments, the at least one waveguide 208-1, 208-2 may be embedded within an elastomeric pad, as illustrated in FIG. 6, and the elastomeric pad may be adhered or embedded as part of the gripping element 204. In some embodiments, the at least one waveguide 208-1, 208-2 may include at least two waveguides.

The at least one waveguide 208-1, 208-2 may be configured to transport a light signal from a light source, which may include multiple light sources 208-1, 208-2, through at least a portion of the gripping element 204. Each light source 212-1, 212-2 may be optically coupled to a respective waveguide of the at least one waveguide 208-1, 208-2. The at least one waveguide 208-1, 208-2 is further configured to transmit the light signal transported, of which at least a portion of the light signal transmitted illuminates the object. The system further comprises a detector (not shown, but similar with respect to the detector 116 of FIG. 1) configured to detect at least a portion of the light transmitted and sense a curvature or a change in curvature of the gripping element 204 with respect to the axis based on the light signal detected. The detector may be optically coupled to a first waveguide 208-1 of the at least one waveguide.

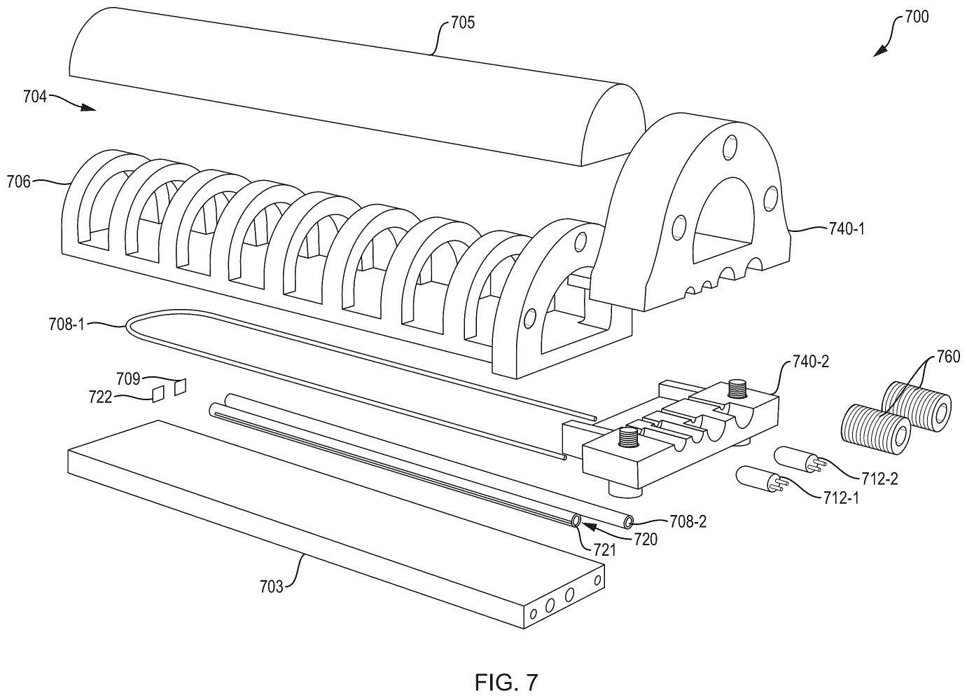

The system 200 further comprises a probe element 220, which may include a probe waveguide configured to collect light reflected from the object. The system 200 further comprises a spectrometer (not shown, but similar with respect to the spectrometer 124 of FIG. 1) optically coupled to the probe element 220 and configured to generate spectral data based on the reflected light collected. The system 200 may further comprise a processor (not shown, but similar with respect to the processor 128 of FIG. 1) communicatively coupled to the detector and the spectrometer. The probe element 220 may include a probe waveguide. Further illustration of the probe waveguide with respect to the probe element 220 is illustrated in FIG. 7.

In some embodiments, a gripper 201 for determining one or more properties of an object may comprise the gripping element 204, the at least one waveguide 208-1, 208-2, and the probe element 220. The gripper 201 may be replaceable, for example, by another gripper of similar construction or a different gripper, in the event of failure of a component of the gripper, e.g., the waveguide 208-1, 208-2, the probe element 220, or the gripping element 204. The at least one waveguide 208-1, 208-2 is configured to enable the coupling of light, for example, from the light source 212, at a first terminus and to transmit the light coupled at a second terminus. The at least one waveguide 208-1, 208-2 may traverse at least a portion of the gripping element 204, the at least one waveguide 208-1, 208-2 transporting at least a portion of the light coupled through a length of the at least one waveguide 208-1, 208-2. The at least one waveguide 208-1, 208-2 is further configured to illuminate the object with at least a portion of the light transmitted. The probe element 220 includes a collection terminus configured to collect reflected light from the object at a point on the gripping element 204 and an output terminus configured to output the reflected light collected. The probe element 220 is configured to transport the light collected from the collection terminus to the output terminus.

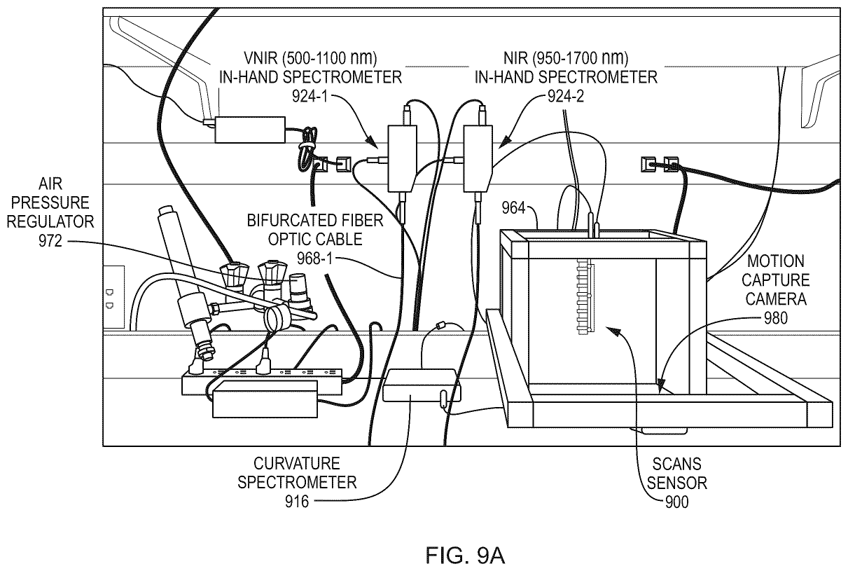

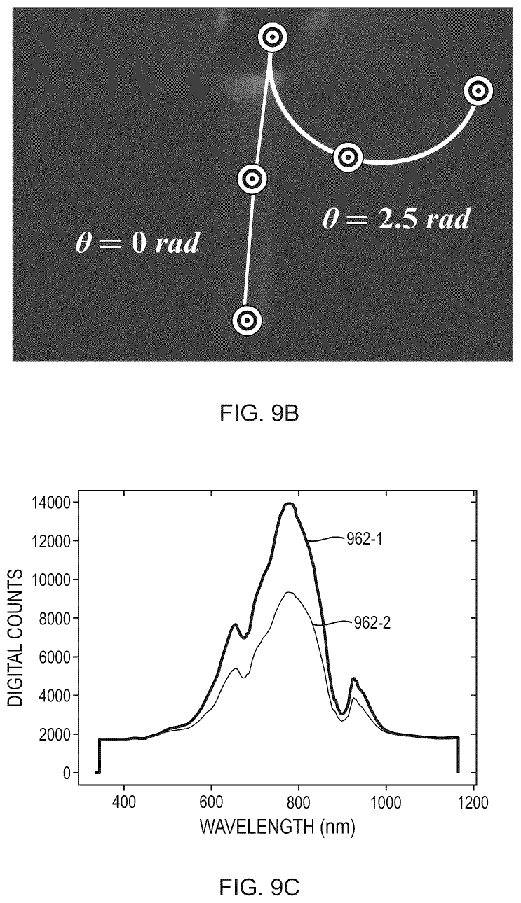

The gripping element 204 may be configured to mount onto or to unmount from a backing 244. The backing 244 may be configured to mount onto and to unmount from a base clamp 240. The backing 244 may be further configured to attach a fluidic connection 248, for example, a pneumatic air connection. The fluidic connection 248 may be fluidically coupled to the inflatable bladder 205. A fluidic actuator (not shown but similar with respect to the air pressure regulator 972 of FIG. 9), for example, an air pump or a fluid pump, may be configured to attach to the fluidic connection to actuate the inflatable bladder 205 to cause the gripping element 204 to bend and to unbend.

The base clamp 240 may be configured to house the light source 212-1, 212-2 and to mount optic connectors 260. The optic connectors may enable optical coupling of an optical fiber or an optical waveguide (not shown) to the waveguide 208-1 of the at least one waveguide or to the probe element 220. The optical fiber or the optical waveguide may transmit a light signal from the waveguide 208-1 or the probe element 230 to the detector or the spectrometer.

The base clamp 240 may be further configured to mount a printed circuit board 252. The printed circuit board may include an electrical connector 264, the electrical connector 264 electrically coupling the light source 212-1, 212-2 to a power source.

In some embodiments, the gripper 201 may include the gripper 201, the base clamp 240, the backing 244, the printed circuit board 252, the optical couplers 260, the light sources 212-1, 212-2, or a combination thereof.

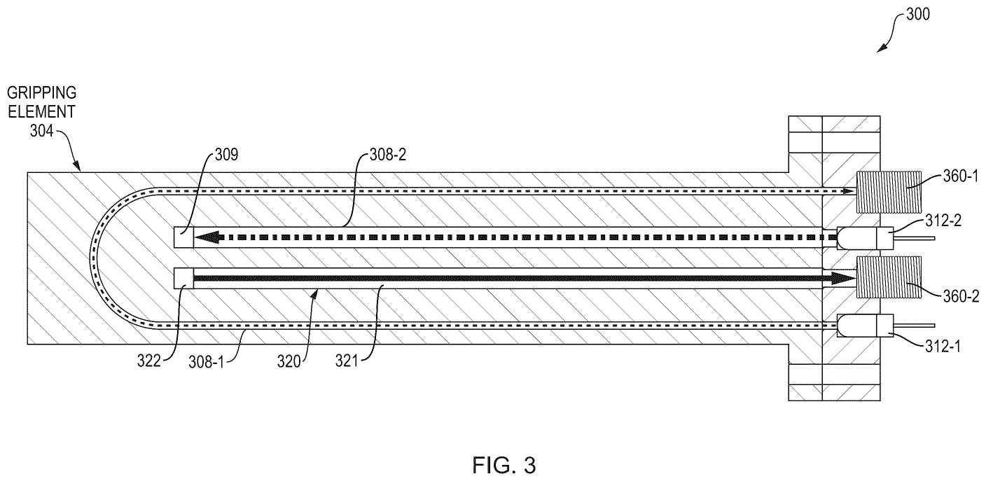

FIG. 3 is a cross-sectional illustration of a gripping element 304 of an example embodiment of a system 300 for determining one or more properties of an object. The system 300 may be similar to the system 100, 200 and includes at least one waveguide 308-1, 308-2 which may include at least two waveguides operatively coupled to the gripping element 304. The system 300 further comprises multiple light sources 312-1, 312-2. A first waveguide 308-1 of the at least one waveguide is configured to transport a light signal from a first light source 312-1 through at least a portion of the gripping element 304 and to transmit the light transported. A detector (not shown, but similar with respect to the detector 116 of FIG. 1) may be configured to detect the light transported and may be optically coupled to the first waveguide 308-1 through a first optical coupler 360-1. At least one second waveguide 308-2 may be configured to transport light from a second light source 312-2 and to transmit the light transported to illuminate the object. An illumination prism 309 may be optically coupled to the at least one second waveguide 308-2 and configured to direct the light transmitted toward the object.

The system 300 may comprise a probe element 320 operatively coupled to the gripping element 304. The probe element 320 may include a probe waveguide 321 and a probe prism 322 optically coupled to the probe waveguide 321. The probe waveguide 321 may be configured to collect light reflected from the object using the probe prism 322. A spectrometer (not shown, but similar with respect to the spectrometer 124 of FIG. 1) may be optically coupled to the probe waveguide 321 through a second optical coupler 360-2 and configured to generate spectral data based on the reflected light collected.

Arrows in FIG. 3 indicate a direction of transmission of light signals.

### Material Quantification and Selection

Soft robotics is a field inherently tied to the selection of materials. Choosing materials with different mechanical properties, such as tensile strength or elastic modulus, impact the operational properties of the soft actuator or sensor.

Optical properties for a number of polymers were evaluated, including optical transmission, refractive index, bend radius, ease of fabrication, glass bonding, and cost. Materials evaluated include platinum cure silicone elastomer, e.g., EcoFlex® and Solaris®, urethane rubber, e.g., Clear Flex®, glass, and PMMA. Results from evaluating the optical properties of the materials are summarized in Table 1.

TABLE 1
Optical properties of waveguide polymers

| | Optical | Refractive | Bend | Ease of | Glass | |
|---|---|---|---|---|---|---|
| Material | Transmission | Index | Radius | Fabrication | Bonding | Cost |
| EcoFlex ® 30 | Poor | 1.4 | Small | Good | Poor | Low |
| EcoFlex ® 45 | Good | 1.4 | Small | Good | Poor | Low |
| Near Clear | | | | | | |
| Solaris ® | Good | 1.41 | Medium | Good | Good | Low |
| Clear Flex ®- | Good | 1.49 | Small | Poor | Excellent | Low |
| 50 | | | | | | |
| PMMA | Good | 1.47 | Medium | Excellent | Excellent | Low |
| Glass Fiber | Excellent | 1.5 | Large | Good | Excellent | High |

### Optical Transmission

Optical transmission was characterized by directing a directed a fiber-coupled light source through a 1 cm thick length each material. As exactly formulation of a PMMA fiber did not exist in a same form factor as other materials, a cut length of a 1 cm length of fiber segment was substituted. The light source was a quartz tungsten halogen (QTH) lamp emitting a broadband spectrum. Transmission measurements for each material type are min-max normalized against transmission through a 1 cm Borosilicate glass cylinder, approximating transmission expected through a fiber optic cable.

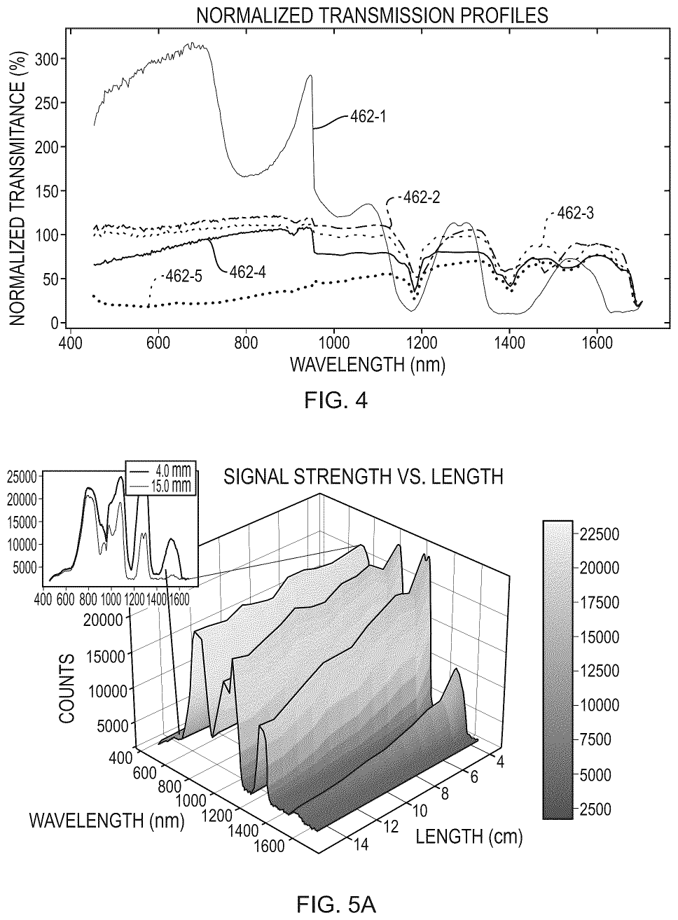

FIG. 4 is a plot of example measurements of transmittance of light of different wavelengths through waveguides composed of different material types. PMMA fiber 462-1 is coated with a cladding and is able to better couple light in a visible range of the electromagnetic spectrum, but still experiences significant absorption wavelengths in a near-infrared (NIR) range. EcoFlex® 30 462-5, a translucent material, significantly scatters light in the very near infrared (VNIR) range of the electromagnetic spectrum, but approximately matches transmission profiles another silicone-based elastomers (EcoFlex® 45 462-4 and Solaris® 462-3) in the NIR range. Of more traditionally flexible materials, Clear Flex 462-2 has excellent optical throughput with one additional absorption trough at 1475 nm. The PMMA fiber is performant in the VNIR range, with larger absorption bands at ≈1175, ≈1400, and ≈1650 nm. While losses for the PMMA fiber might appear significant, insertion loss, a quantity of light that is lost per unit length of a waveguide, must be considered as well. Silicone and urethane materials lose over 50% of light per 1 cm segment of material in similar wavelength bands. Increasing lengths of fibers for the silicone and the urethane materials corresponds to diminishing transmitted light. For instance, if a proportion of transmitted light at 1175 nm in a urethane rubber is considered to be 0.5/cm, a proportion of light transmitted through a 10 cm length of urethane rubber will be 0.5¹⁰=0.00098. Knowing that optical loss compounds as a function of length of a material, materials with near 100% transmission outside of absorption bands are preferred over materials with lower percentage transmission. While some embodiments of clear urethane rubbers, by pure optical transmission, appear superior, the embodiments may be challenging to reliably form into repeatable waveguide.

### Refractive Index

Refractive Index (RI) is a dimensionless quantity defining an extent light is refracted when passing through a material. RI is considered because it directly contributes to a fiber's ability to accept and transmit light along a length of the fiber.

### Numerical Aperture

For spectroscopic applications, waveguides transmit light to a surface and receive light reflected from the surface, transmitting the light reflected received to a detector or a spectrometer. Numerical aperture (NA) is defined as a range of angles from which a fiber will accept incoming light. This is also commonly known as an acceptance cone, from which rays of incident light will be propagated through a multi-mode fiber. Mathematically, it is defined as:

$$NA = {n}_{0} sin {θ}_{max}$$

$$NA = \sqrt{{n}_{core}^{2} - {n}_{clad}^{2}}$$

n₀ is a refractive index of a medium at a terminal end of a fiber, which is assumed to be air and approximately equal to 1. n_{core} is an RI of a core material and n_{clad} is an RI of a cladding material for the fiber. In the first definition, θₘₐₓ is a half-angle forming the acceptance cone. NA is significant in evaluating waveguide materials as maximizing the acceptance cone also maximizes a total number of photons transmitted through a waveguide. An ideal waveguide should have a large NA, which means the core material and the cladding material must have a wide range between their respective refractive indices. For traditional waveguide applications, coupling a small amount of light through the fiber is sufficient as the photodetectors used to receive and process the light have a broad detection range. For spectroscopic applications, maximizing the acceptance cone and the optical transmission may be helpful toward achieving sufficient optical signal for material analysis by a spectrometer. A larger NA also minimizes effects of slight misalignment between a light source and the fiber and between a grasped object and the fiber.

### Total Internal Reflection

Once light is coupled into a waveguide, the light coupled is transmitted through a length of a fiber. As previously described, optical transmission depends on a material from which a waveguide is formed; however, a relationship between a RI of two materials used to construct a core and a cladding is critical to ensure light accepted into the fiber is transmitted along the length of the fiber. Total internal reflection occurs when light traveling through the core of the fiber is incident on the cladding of the fiber and is reflected entirely back through the core without being refracted through the cladding. For a multi-mode fiber constructed of the core surrounded by the cladding, a smallest angle of incident light, normal to a boundary of the cladding and the core, that will yield total internal reflectance is known as a critical angle. Mathematically, the RI of the core and the cladding are related by using Snell's law.

$${θ}_{c} = arc sin \frac{{n}_{clad}}{{n}_{core}}$$

The critical angle has consequences when a gripper or a gripping element of a system for determining one or more properties of a system is actuated. As a waveguide is bent, a change in a geometry of the optical fiber decreases the angle of light incident within a bent region of the waveguide. If the angle exceeds the critical angle, light will be lost through the cladding.

An ideal spectroscopic waveguide should have a difference between the RI of the core and the RI of the cladding, and N_{clad}<N_{core}. Such a relation between the RI of the core and the RI of the cladding will increase an amount of light accepted into the fiber while also minimizing an amount of light that is lost through the cladding during transmission. Because an RI of a single material is not sufficient to evaluate a material's suitability for waveguide construction, all materials are weighted equally for total internal reflection. Additionally, results show that a compression of a waveguide profile also affects the critical angle, causing light loss correlated with contact pressure. PMMA fibers are not easily compressed radially, thus eliminating a complicating source of light loss for this material type.

As a result, waveguides, similar to the waveguide 108, 208-1, 208-2, 308-1, 308-2 may be configured to enable a change in a characteristic of a light signal transported. The characteristic may be an intensity of the light signal, and a curvature of a gripping element, for example, the gripping elements 104, 204, 304, may be sensed based on a change in the intensity of the light signals. In some embodiments, the characteristic changed of the light signal may be polarization or coherence, for example, a loss of polarization or a loss of coherences of the light signal, respectively.

### Bend Radius

Bend radius defines a radius of a circle a fiber may form before irreparable damage occurs to a material of the fiber. Bend radii for glass fiber optic cables are well-defined and are rated by manufacturers for long-term and short-term configuration. As glass-core fibers are fragile, a bend radius for the glass-core fibers is large to prevent fracturing a glass core. Crystalline structures of glass prevent plastic deformation; curvature beyond the bend radius results in brittle failure. Silicone elastomers and urethane rubbers are elastic materials capable of bending back on themselves without causing lasting damage to a casting of the elastic materials. Solaris®, while more flexible than glass, is notably less elastic than EcoFlex® and Clear Flex®. Imperfections in or damage to Solaris® tend to propagate through material as it is bent. PMMA is more flexible than glass but less flexible than cast elastomers, for example, EcoFlex and Clear Flex®, and represents a compromise. Visibly noticeable plastic deformation in fibers of PMMA only occurs at a bend radius of less than 1 cm, which is much smaller than conformal states of most soft grippers.

### Glass Bonding

Waveguides are excellent at transmitting light along a length of material; however, waveguides are not suited towards redirecting light at a right angle to a primary axis without additional optical engineering. Redirecting light may be achieved by pairing the waveguides with a micro-machined glass prism. The glass prism may be composed of borosilicate. The glass prism may be isosceles right angle 45°-90°-45° prisms. For use in soft sensors, a bonded optical waveguide and prism should be optically transmissive and robust to delamination. Prism glass can be bonded with other glass fiber optics using optical adhesives. Extremely elastic silicone materials bond poorly to rigid, smooth surfaces like glass. Solaris®, which is designed as an encapsulating material for solar panels, bonds to glass with proper surface preparation and a primer. PMMA bonds well to glass using either optical adhesives or cyanoacrylate.

### Cost

Ideal soft sensors are cost-effective and easy to replace when damaged or fatigued. Low-cost sensors also enable adoption of a sensing medium to additional researchers or users for exploration and replication. Cast elastomer materials must be purchased in bulk, but an amount needed to fabricate a single waveguide using the cast elastomer materials is a small volume (<50 g) per cast. Previous applications have used lensed fiber optics, the lensed fiber optics costing $200/per fiber and being highly fragile. PMMA fibers may be available at around $0.1/meter of material.

### Ease of Fabrication

Degassing cast materials is necessary to avoid a presence of bubbles in molded waveguides. The presence of bubbles, for example, trapped air pockets, in the waveguides may cause unexpected loss, which may be significant when sizes of the trapped air pockets relative to a thickness of the waveguide are close. Silicone elastomers have longer pot lives and easily fill molds when cast. Urethane rubbers may thicken quickly and may be difficult to fully degas and set without lasting surface tack; moreover, urethane rubbers may exhibit shrinkage while molding (≈1 mm). Unexpected size differences result in challenges in forming a tight mechanical bond to cladding material. Because PMMA fibers and glass fibers are pre-formed to a set diameter with cladding, fabrication consists of bending PMMA material or glass fiber material to a desired shape and cleaving a smooth cut at terminal ends. However, glass fibers may require cleaving using specialized tools and polishing to avoid scattering from rough fiber ends.

### Insertion Loss

With respect to PMMA, experiments were conducted to evaluated optical loss as a function of a length of a waveguide. Knowing how spectral intensity decreases as a function of the length of a fiber enables identification of regions of the electromagnetic spectrum with degraded sensitivity when analyzing signals produced by the waveguide. Spectral intensities are measured through segments of PMMA fibers ranging from 4-15 cm in length. The fibers were optically coupled to a QTH light source and a pair of visible-short wave infrared (VIS-SWIR) spectrometers. Insertion losses were calculated as follows:

$$Loss ( dB ) = - 10 {log}_{10} \frac{{S}_{i} ( λ )}{{S}_{0} ( λ )}$$

wherein Si(λ) is a digital count reading from the spectrometers at wavelength λ of length i and S0(λ) is a digital count reading from the spectrometers without attenuation. To avoid saturating the spectrometers, S₀ is approximated as a 4 cm length of fiber. Measurements of the insertion losses indicate that insertion loss is not uniform across the electromagnetic spectrum. Absorbances become more pronounced as the length of the waveguide increases. Of particularly note, very little available light transmitted between 1100-1200 nm and greater than 1400 nm.

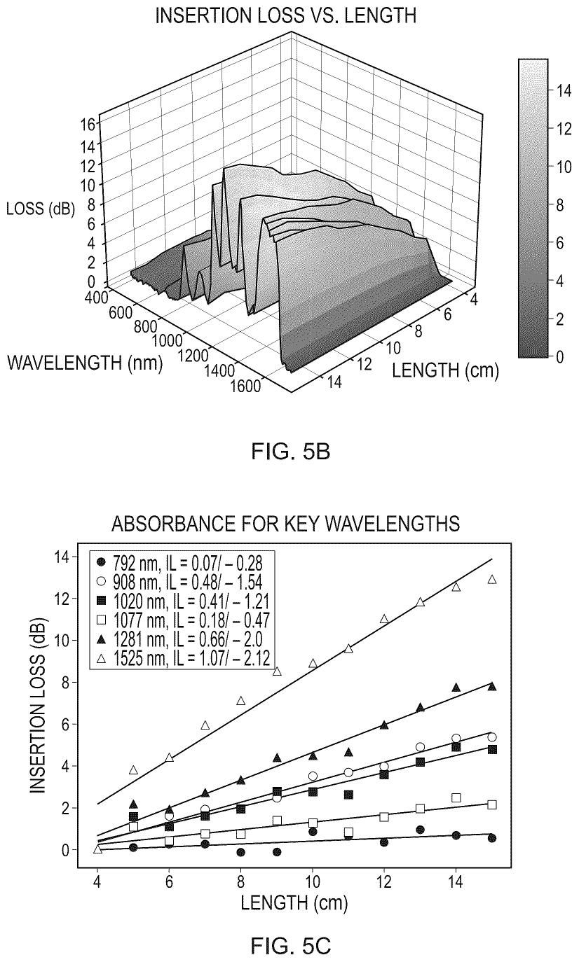

FIG. 5A is a surface plot of example measurements of light transmittance of different wavelengths through waveguides composed of polymethyl methylacrylate (PMMA) of different lengths, with an inset illustrating the light transmittance for a fiber of 4 mm length and a fiber of 15 mm length.

FIG. 5B is a surface plot of example measurements of insertion loss of light of different wavelengths through waveguides composed of PMMA of different lengths. As previously described, insertion losses are computed based on light transmittance for a given wavelength and length of fiber versus a reference light transmittance for the given wavelength and a fiber of 4 cm length.

Based on results from FIGS. 5A and 5B, a function of loss at specific target wavelengths may be computed.

FIG. 5C is a plot of example measurements of insertion loss versus length at specific wavelengths representing points of strong absorption and reflection as determined by FIG. 5B. The insertion losses for all wavelengths increase linearly. A legend indicates fit regression line for each wavelength using ordinary least squares. The fit regression lines indicate a non-zero insertion loss by virtue of directing light through any length of PMMA fiber. The insertion losses, or the absorption of the PMMA fiber, are not uniform across all wavelengths of light. For instance, light at 792 nm is lost at 0.07 dB/cm while light at 1525 nm is lost at 1.07 dB/cm, or nearly an order of magnitude greater than light lost in a VNIR range.

### Materials and Fabrication

FIG. 6 is a stepwise illustration of an example fabrication process for a gripper for determining one or more properties of an object. The example fabrication process for the SCANS sensor is completed using molding and casting to create a thin sensor pad which can be adhered to a multitude of actuator designs. (1) Each part of a two-part DragonSkin®-20 elastomer is measured in equal weights and mixed by hand. Titanium Dioxide (TiO₂) pigmentation may be added to act as a secondary cladding. A mass of TiO₂ powder equivalent to 5% of a mass of the DragonSkin® is added. (2) A mixture of the TiO₂ and the DragonSkin® is combined using a planetary centrifugal mixer for 3 minutes to disperse pigmentation evenly in the mixture and remove air bubbles. (3) The mixture is poured into a 3D-printed, nylon mold and leveled at a top of the mold with a mixing stick. The mold creates negative space for later placement of optical components. (4) The mold is placed inside a pressure molding chamber. The pressure molding chamber is pressurized to a pressure of 550 kPa and brought to a temperature 60 degrees C. Curing of the mixture in the mold creates a sensor pad.

(5) Fibers, for example, waveguides, are prepared for the gripper. The fibers have a PMMA core with a Refractive Index (RI) of 1.50 and an outer cladding of fluorinated polymers with a RI of 1.40. A Numerical Aperture (NA) of the fibers is 0.54 and a critical angle is 69 degrees. Fibers of different sizes may be used for different waveguides. Waveguides for evaluating curvature may have one diameter and waveguides for spectroscopy may have a second diameter. For example, a first waveguide, similar to the first waveguide 208-1 of FIG. 2 may have a diameter of 1.5 mm. An at least one second waveguide, similar to the at least one second waveguide 208-2 of FIG. 2, may have a diameter of 2.5 mm. Likewise, a probe waveguide of a probe element, similar to the probe element 220 of FIG. 2, may have a diameter of 2.5 mm.

The fibers are trimmed using a fiber cleave to a correct length, including 1 cm of excess beyond a length of a molded finger, for example, a length of the sensor pad of step (1)-(4). A 3.0 mm micro-machined prism with aluminum coated hypotenuse may be cleaned with isopropyl alcohol. The machined prism and the cleaved fibers may be aligned, for example, using a 3D printed alignment jig. A small bead of cyanoacrylate may be used to adhere the fibers to the prisms and allowed to set. (6) The sensor pad may be removed from the molding chamber and deflashed. The sensor pad may be placed in a secondary mold, the sensor pad having a negative space facing upwards. An alignment end cap is clamped to the secondary mold to hold terminal ends of the fiber in place during secondary curing. The fibers are press-fit into respective cavities, e.g., the negative space. (7) An additional mixture of the DragonSkin® and TiO₂ may be poured to cover the fibers in 1 mm of material. (8) The mixture is placed into the pressure chamber for a secondary curing using the same pressure and temperature as the first cure. (9) The sensor pad is removed from the secondary curing and deflashed. Excess material covering an exposed face of the prism on the sensor pad is carefully trimmed away. The sensor pad may be bonded to a or embedded in an exoskeleton of an actuator, for example, a finger exoskeleton of a soft actuator.

FIG. 7 is an exploded diagram of an example embodiment of a system 700 for determining one or more properties of an object. The system 700 may be similar to the system 200, 300, with similar components labeled with like reference numbers. The system 700 may comprise a gripping element 704 with an inflatable bladder 705 and an exoskeleton 706. The system may further comprise a sensor pad 703 similar to the sensor pad created in the described procedure of FIG. 6. The sensor pad 703 may be coupled to the gripping element 704. In some embodiments, the sensor pad 703 may be embedded into the exoskeleton 706 of the gripping element.

The sensor pad 703, the gripping element 704, or a combination thereof may be clamped with an adapting mount 740-1, 740-2. The sensor pad 703 may be further configured to come into contact with the object. The adapting mount 740-1, 740-2 may be configured to align the at least one waveguide 708-1, 708-2 to a light source, which may include light sources 712-1, 712-2. The adapting mount may further be configured to couple optically a first waveguide 708-1 of the at least one waveguide and a probe element 720 to a detector or a spectrometer (not shown but similar with respect to the detector 116 and the spectrometer 124, respectively, of FIG. 1) using optical adapters 760. Input light may be generated from the light sources 712-1, 712-2, which may emit light of a single wavelength or a plurality of wavelengths. The light sources 712-1, 712-2 may shine light of a same spectral profile or of different spectral profiles. Each light source 712-1, 712-2 may be optically coupled to a respective waveguide 708-1, 708-2. The light source may be a QTH lamp.

A terminus of the first waveguide 708-1 of the at least one waveguide and a probe waveguide 721 of a probe element 720 may be mounted flush with the optical adapters 760. The first waveguide 708-1 and the probe waveguide 721 may be optically coupled to the detector or the spectrometer with fiber optic cables, for example, low hydroxyl ion (OH) concentration, 1000 micron, 0.5 NA glass fiber optic cables. The fiber optic cables couple outputs of the waveguides to the spectrometer or the detector while minimizing the amount of light lost in transit. A large NA helps minimize effects of fiber-waveguide misalignment.

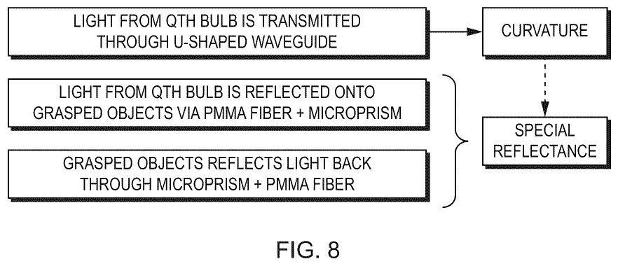

FIG. 8 is a flow diagram of an example method for determining one or more properties of an object. With reference to FIG. 7, the first waveguide 708-1 of the at least one waveguides may be a curvature sensing waveguide. The curvature sensing waveguide transmits light from a first light source 712-1 of the light sources through at least a portion of the gripping element 704 to the detector. As the sensor pad 703 is bent, light is lost in the curvature sensing waveguide, and a signal strength of the curvature sensing waveguide can be used to infer or to sense a curvature or a change of curvature of the gripper. For spectroscopic operation, a second waveguide 708-2 of the at least one waveguide may be configured to transmit light from a second light source 712-2 through an illumination prism 709 to the object. A probe prism 722 of the probe element 720 collects light reflected from the object, the light reflected transmitted to the spectrometer by the probe waveguide 721. A calibration factor may be determined using the curvature sensed or the change in curvature sensed by the curvature sensing waveguide and the detector. Raw readings from the light reflected from the object may be used to generate spectral data and to infer a class or material of the object. All waveguides may be constructed from the same material composition and are thus subject to the same rates of light loss. The calibration factor may be applied to the spectral data.

In some embodiments, a detector may be a second spectrometer. In other embodiments, the probe waveguide and the curvature sending waveguide may be optically coupled to a single spectrometer. The coupling may comprise an optical switch.

### System Characterization

FIG. 9A is an illustration of an example experiment to characterize optical transmission as a function of a curvature of a system for determining one or more properties of an object. A SCANS sensor system 900 is mounted on a platform 964. The system 900 may be similar to the system 100, 200, 300, 700. The system 900 may include a first waveguide of at least one waveguide configured to sense curvature (not shown, but similar with respect to 208-1, 308-1, 708-1) optically coupled to a detector 916, which may be a spectrometer. The system 900 may further include a probe element (not shown, but similar with respect to the probe element 120, 220, 320, 720) optically coupled to a spectrometer, which may include multiple spectrometers 924-1, 924-2. The multiple spectrometers may measure optical signals at different spectral ranges and spectral data generated from the multiple spectrometers may be combined to generate a unified spectral signal. The first waveguide and the probe element may be optically coupled to the respective spectrometers using respective optical fibers 968-1, 968-2. The system 900 may be actuated by an air pressure regulator 972. Regulated air pressure is supplied to a fluidic control board to control actuation of the system. Devices and actuation of the fluidic control board are managed by a Ubuntu 20 personal computer with a real-time operating system. A motion capture camera 980 is configured to detect a curvature of the system.

FIG. 9B is an illustration of example configurations of the system of FIG. 9A in different bending configurations as captured by the motion capture camera. The SCANS sensor is instrumented with three retroreflector dots at a tip, midpoint, and base of a finger of the SCANS sensor. The system is initially reflectance calibrated in an unactuated position by contacting a piece of Spectralon™ with the system. Dark counts are collected by covering the system and collecting a reading in an absence of light. A single motion capture camera, e.g. the motion camera 980, tracks a position of the three retroreflector dots in real-time. FIG. 9B illustrates the retroreflector dots captured for the SCANS sensor in an unactuated position and a fully actuated position.

FIG. 9C is a plot of example measurements of light transmission across a spectral range for the system of FIG. 9A in an unactuated state 962-1 and an actuated state 962-2, indicating loss of light in the system under bending conditions.

### Curvature Metrics

To measure curvature of a soft gripper or a finger, consider a soft finger with a fixed length l. By assuming the finger will bend only around a primary axis of curvature and will not experience flexion in other axes, motion of the finger may be approximated by a circle C with radius R. When R−>∞, a circumference of the circle approaches ∞ as the circumference is given by 2πR.

Returning to the soft gripper and relating to the circle, an unactuated finger has no curvature and an associated circle would be infinitely large. As the soft gripper is actuated, the finger begins to assume a progressively more curved shape, which may be considered an increasingly larger arc length of a circle with continually decreasing radius.

Therefore, curvature measurements become a function of an angle of a central angle θ, which may be estimated by tracking a position of points on the finger. To do so, the finger may be mounted on a rigid surface with a base position denoted as bₓ, b_{y}. A position of a tip of the finger farthest away from the base coordinate while unactuated is given by t_{x,0}, t_{y,0}. A distance on the circle between two points is given by l, the length of the soft finger. When actuated, a position of t shifts to t_{x,θ}, t_{y,θ}.

Knowing for all values θ, t will lie on the circle. With a motion capture system like the motion capture camera 980 of FIG. 9A, the position of t may be observed. While methods that derive a circle given two points and a tangent line exist, calculators are much simpler when introducing a third point to define a curvature of the circle. For simplicity, this point may be placed on a midpoint of the finger mₓ, m_{y}. At any given time, a system of linear equations that defines the circle may be written as:

$${( {b}_{x} - {c}_{x} )}^{2} + {( {b}_{y} - {c}_{y} )}^{2} - {R}^{2} = 0$$

$${( {m}_{x} - {c}_{x} )}^{2} + {( {m}_{y} - {c}_{y} )}^{2} - {R}^{2} = 0$$

$${( {t}_{x} - {c}_{x} )}^{2} + {( {t}_{y} - {c}_{y} )}^{2} - {R}^{2} = 0$$

In this formulation, c is a coordinate of a center point of a formed circle and R is the radius of the circle C with arc length l. Solving the system of linear equations yields cx, cy, and R. Euclidean geometry may be used to calculate the angle of the arc length. Given t and b define ends of the arc, the distance R is equally a distance from the center point c to the two points t and b.

$${c}^{2} = {a}^{2} + {b}^{2} - 2 ab cos ( θ )$$

$${‖ t - b ‖}^{2} = {R}^{2} + {R}^{2} - 2 {R}^{2} cos ( θ )$$

$${( {b}_{x} - {t}_{x} )}^{2} + {( {b}_{y} - {t}_{y} )}^{2} = 2 {R}^{2} - 2 {R}^{2} cos ( θ )$$

$$\frac{{( {b}_{x} - {t}_{x} )}^{2} + {( {b}_{y} - {t}_{y} )}^{2} - 2 {R}^{2}}{2 {R}^{2}} = cos ( θ )$$

$$arccos ( \frac{{( {b}_{x} - {t}_{x} )}^{2} + {( {b}_{y} - {t}_{y} )}^{2} - 2 {R}^{2}}{2 {R}^{2}} ) = θ$$

### System Demonstration

### PMMA as Curvature Waveguide

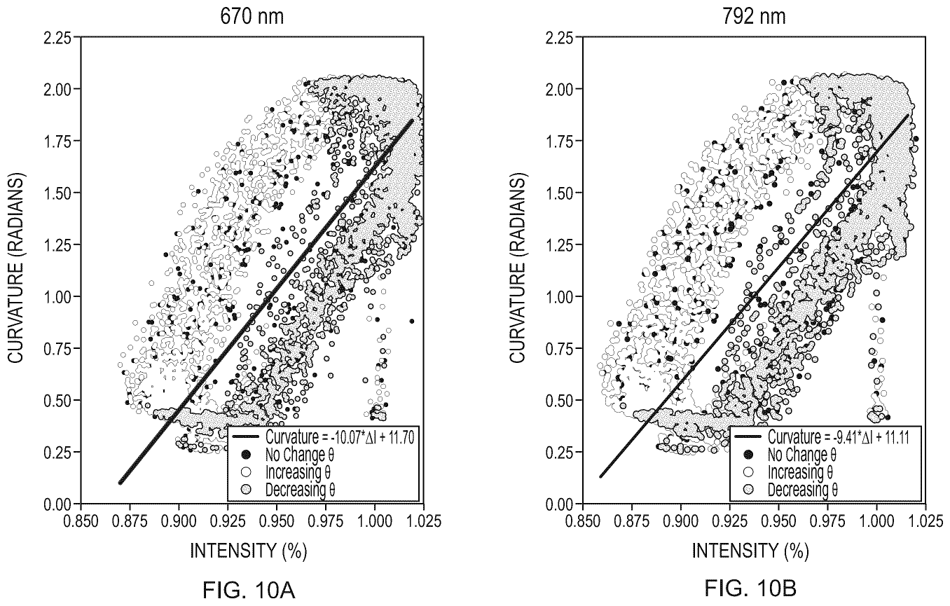

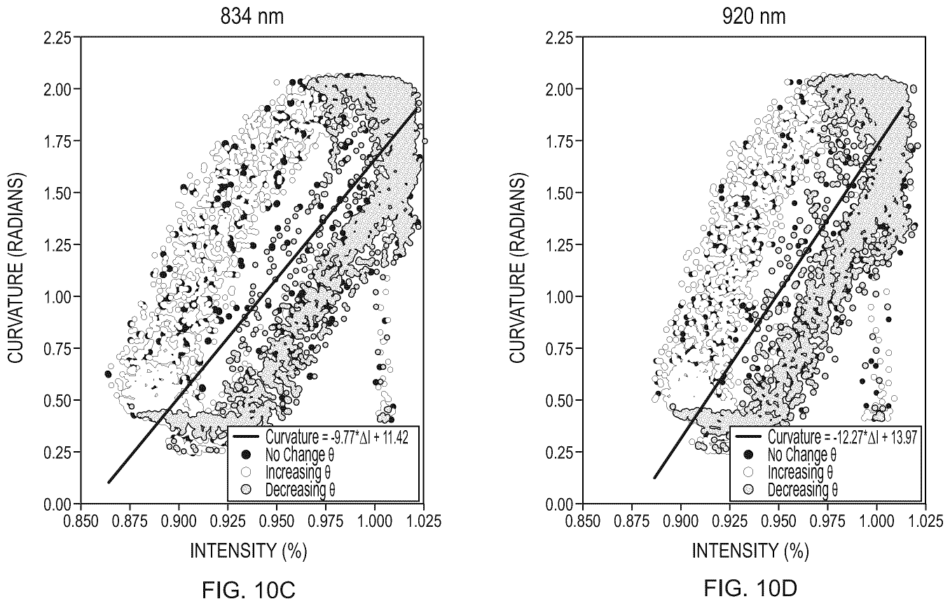

FIGS. 10A-10D are plots of example measurements of curvature measured by a motion sensor and curvature measured by an optical waveguide at different wavelengths for a system for determining one or more properties of an object. Curvature sensing abilities of the SCANS sensor is evaluated by actuating a finger over 100 inflation-deflation cycles. The plots of FIGS. 10A-10D illustrate calculated curvature θ versus optical intensity, the optical intensity represented as a function of a ratio of current intensity Iₜ to an unactuated intensity I₀. The curvature is calculated using a motion sensor similar to the motion capture camera 980. The intensity is measured by a curvature spectrometer, for example, the curvature spectrometer 916, configured to detect light from at least one waveguide. Measurements are acquired for illumination wavelengths of 670 nm (FIG. 10A), 792 nm (FIG. 10B), 834 nm (FIG. 10C), and 920 nm (FIG. 10D). An amount of hysteresis is present as the curvature spectrometer acquires a reading over 10 ms, resulting in a slight lag behind the motion sensor. Ground truth measurements are published at a rate of 30 Hz. Unaltered PMMA fibers exhibit a linear trend in intensity loss to approximately 85% of an initial signal strength as the finger is bent to full curvature. PMMA waveguides may be altered to induce greater light loss with respect to bending to improve curvature sensing capabilities, for example, by sanding a PMMA fiber's outer cladding.

### Sample Spectral Elements

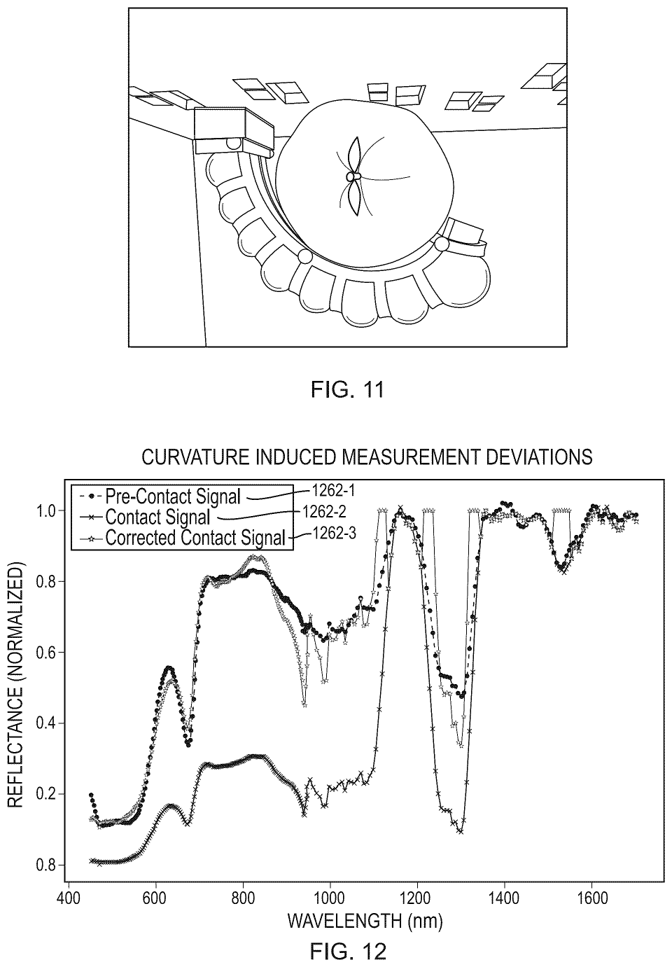

FIG. 11 is an illustration of an example embodiment of a system for determining one or more properties of an object, the system grasping an object. The system may be similar to the system 100, 200, 300, 700 and is actuated into a bent state to grasp an apple.

FIG. 12 is a plot of example spectral measurements of a system for determining one or more properties of an object in unactuated 1262-1 and actuated 1262-2 bending configurations, along with spectral data calibrated 1262-3 based upon measurements of a curvature of the object. Spectral measurements of a pre-contact state, e.g., unactuated 1262-1, and spectral measurements of a contact state, e.g., actuated 1262-2, indicate significant curvature induced measurement deviations. Calibration of the spectral measurements of the contact signal may be performed if the curvature of the system known. A calibration factor may be applied to the spectral measurements of the contact state to generate a corrected contact measurement. The corrected contact measurement, i.e., the calibrated spectral data 1262-3, exhibits greater similarity with the spectral measurements of the pre-contact state.

An embodiment of a system for determining one or more properties of an object is further evaluated using a selection of household items. The selection includes visually confusing samples, including real applies and faux apples. Baby oil (mineral oil), water, and isopropyl alcohol inside glass bottles are included to evaluate system performance on visually clear items.

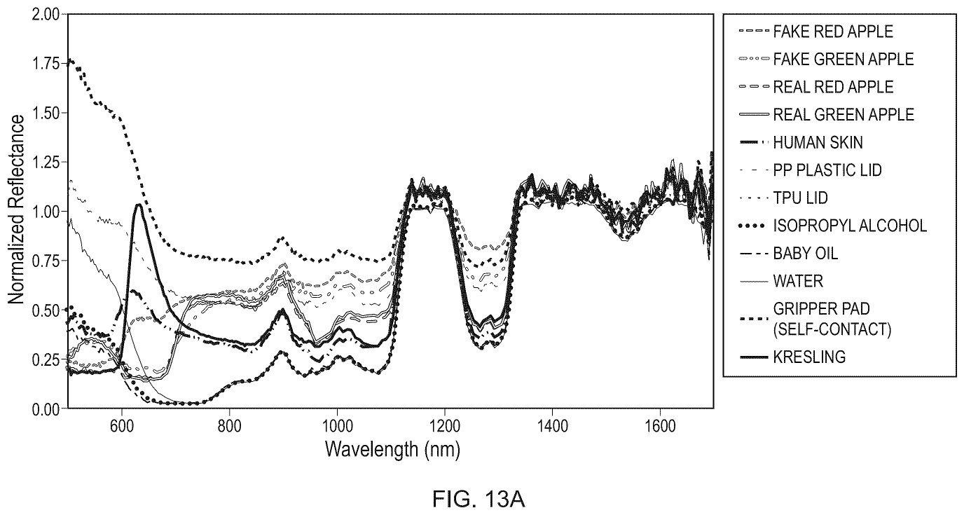

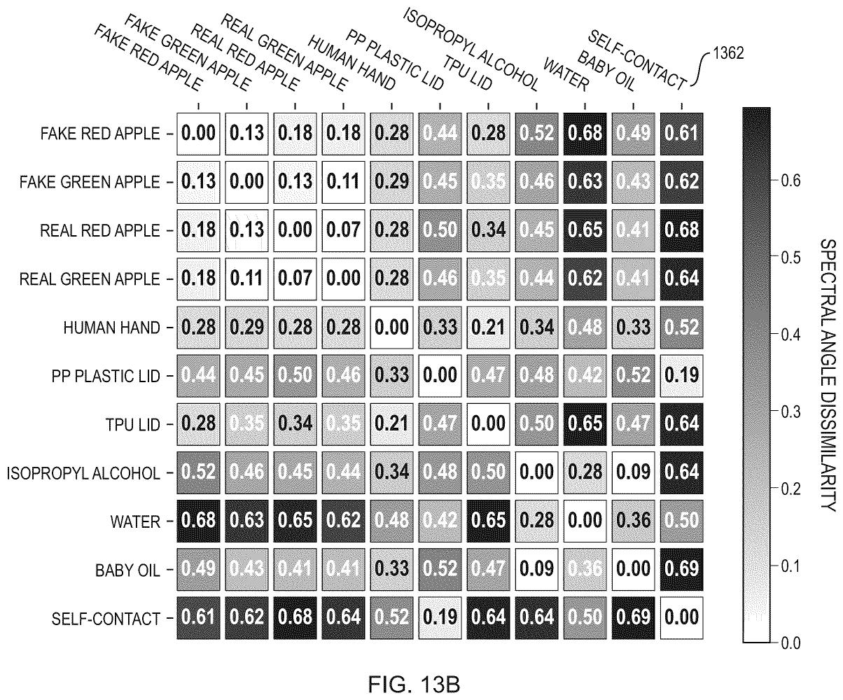

FIG. 13A is a plot of example spectral measurements using a system for determining one or more properties of an object on a selection of household items. The plot illustrates average spectral reflectance-normalized profiles. Spectral data for real fruit is similar to spectral data for faux fruit under visible light, but the spectral data for the real fruit, including a real red apple and a real green apple, reveal a strong absorbance centered at 1275 nm not present in the spectral data for the faux fruit. Spectral data for a human hand is also markedly distinct from spectral data for organic fruits and for an assortment of plastic items.

FIG. 13B is a plot of dissimilarities between the spectral measurements of the selection of household items of FIG. 13A. All collected spectral signatures are compared with respect to each other, and larger scores in FIG. 13B indicate greater distinction between shapes of the respective spectral measurements. A significant observation includes a strong change that occurs when an object is brought in front of a sensor. “Self-contact” measurements 1362 indicate dissimilarities between the selection of household items and a sensor pad of the system, indicating strong recognition of a presence of an object versus no object present. Future identification of grasped objects may be able to leverage dissimilarities between spectral profiles, and a system may be configured to recognize the grasped objects based on a database of curvatures, spectral signatures, or a combination thereof or based on a machine learning model or an inference model.

In an additional example embodiment, a method for determining one or more properties of an object may comprise transporting a light signal through at least a portion of a gripping element configured to bend with respect to an axis. The method may further comprise sensing a curvature or a change in curvature of the gripping element with respect to the axis based on the light signal transported. The method may further comprise illuminating the object, collecting reflected light from the object, and generating spectral data based on the reflected light collected. The spectral data may be calibrated based on the curvature or change in curvature sensed. The method may further comprise determining the one or more properties of an object based on the calibrated spectral data, the curvature sensed, or a combination thereof.

In some embodiments, transporting the light signal through at least a portion of the gripping element changes a characteristic of the light signal transported based on a state of the gripping element. In other embodiments, determining the one or more properties of the object includes using a machine learning model or an inference model.

In some embodiments, the method may further comprises acquiring a set of reference properties for the object through use of the gripping element and storing the set of reference properties acquired. The method may still further comprise grading additional objects of a similar type to the object through use of the gripping element based on the reference properties stored. Grading the additional objects may include, without limitation, determining ripeness of fruit, freshness of food products, or type of a household, waste, recycling, or medical product, among others. Grading the additional objects may be based on the spectral data generated, the curvature sensed, the calibrated spectral data, or a combination thereof. Acquiring the set of reference properties for the object may include acquiring reference properties over a substantially full range of bending with respect to the axis of the gripping element through use of objects of a similar type over a range of sizes.

In another example embodiment, a system for determining one or more properties of an object may comprise means for sensing a curvature or change in curvature of a gripping element configured to bend along at least one direction with respect to axis based on a change in a property of a light signal transported through at least a portion of the gripping element. The system further comprises means for generating spectral data of the object based on light reflected from the object, the light reflected combing from a known source, and for calibrating the spectral data generated based on the curvature or change in curvature sensed. The system still further comprises means for determining one or more properties of the object based on the curvature or change in curvature sensed, the calibrated spectral data, or a combination thereof.

Embodiments of systems, grippers, and methods for determining one or more properties of an object may present a number of advantages, including recognition of a grasped object by soft grippers into broad categorizations, object sensing prior to actuation of a robot or a gripper, and chemical property analysis, e.g., ripeness of fruits. Additional benefits may include increased flexibility and robustness to fatigue from bending as well as calibration of spectroscopic measurements based on bending of the robot or the gripper, the bending changing a transmission of light through the gripper. Properties sensed may include one or more of a curvature or a change incurvature, size, shape, color, composition, quality, material, class, content, texture, a chemical property or a physical property.

Example applications of the embodiments described may include differentiating types of plastic in a recycling process line, determining ripeness of fruit via chemical composition, measuring sizes of recyclable objects as grasped, manipulating and recognizing household objects, and gentle handling of humans in healthcare settings.

This application is related to U.S. application Ser. No. 18/165,707 (INV-22051; 5200.2325-001), entitled “Systems and Methods for Robotic Grippers with Fiber Optic Spectroscopy,” the teachings of which are incorporated herein by reference in their entirety.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A system for determining one or more properties of an object, the system comprising:
a gripping element configured to bend with respect to an axis;
at least one waveguide, operatively coupled with the gripping element, configured to transport a light signal from a light source through at least a portion of the gripping element, the at least one waveguide further configured to transmit the light signal transported, at least a portion of the light signal transmitted illuminating the object;
a detector configured to detect at least a portion of the light signal transmitted and to sense a curvature or a change in curvature of the gripping element with respect to the axis based on the light signal detected;
a probe element operatively coupled with the gripping element, the probe element including a probe waveguide configured to collect reflected light from the object;
a spectrometer optically coupled to the probe element and configured to generate spectral data based on the reflected light collected; and
a processor, communicatively coupled to the detector and the spectrometer, configured to apply a calibration factor to the spectral data generated based on the curvature or the change in curvature sensed to produce calibrated spectral data and to determine one or more properties of the object based on the curvature or the change in curvature sensed, the calibrated spectral data, or a combination thereof.

2. The system of claim 1, wherein the at least one waveguide is configured to enable a change in a characteristic of the light signal transported based on a bending of the waveguide.

3. The system of claim 2, wherein the characteristic of the light signal is an intensity of the light signal and further wherein the detector is configured to sense the curvature or the change in curvature of the gripping element based on a change in the intensity of the light signal detected.

4. The system of claim 2, wherein the detector is further configured to acquire a first measurement of the characteristic of the light signal transmitted and a second measurement of the characteristic of the light signal transmitted, the detector further configured to sense the curvature or change in curvature based on a difference between the first measurement and the second measurement.

5. The system of claim 1, wherein the waveguide and the probe waveguide include a polymer core and a polymer cladding, the polymer core composed of polymethyl methacrylate, urethane rubber, or other polymer, the polymer cladding composed of fluorinated polymer or other polymer.

6. The system of claim 1, wherein the light source illuminates at a single wavelength or a plurality of wavelengths.

7. The system of claim 1, wherein the at least one waveguide includes at least two waveguides, a first waveguide of the at least two waveguides configured to illuminate the object and at least one second waveguide of the at least two waveguides configured to transport the light signal from the light source and to transmit the light signal transported to the detector.

8. The system of claim 1, further comprising a plurality of light sources, the at least one waveguide including a respective waveguide configured to transport the light signal from a corresponding respective light source and to transmit the light signal transported.

9. The system of claim 8, wherein spectral characteristics of the plurality of light sources is different, and wherein the plurality of light sources includes a first light source with a first spectral characteristic configured to illuminate the object and at least one second light source with a second spectral characteristic configured to transmit light signal through a corresponding respective waveguide to the detector.

10. The system of claim 1, wherein the detector is configured to detect the light signal transported at a single wavelength or a plurality of wavelengths, the detector further configured to sense the curvature or the change in curvature of the gripping element based on the light signal detected at a single wavelength or at least one sub-band of the plurality of wavelengths.

11. The system of claim 1, wherein the properties of the object include a curvature or change in curvature, size, shape, color, composition, quality, class, material, content, texture, a chemical property, or a physical property.

12. The system of claim 1, wherein the gripping element includes an elastomeric pad that is arranged to come into contact with the object, and wherein the waveguides are in coupled arrangement with the elastomeric pad.

13. The system of claim 1, wherein the gripping element is configured to bend along multiple directions with respect to the axis.

14. The system of claim 1, wherein the gripping element is a first gripping element and wherein the system includes at least one second gripping element, further wherein the first gripping element, the at least one second gripping element, or a combination thereof is configured to grasp the object and to determine the one or more properties of the object.

15. The system of claim 1, wherein the processor is configured to determine the one or more properties of the object by comparing the curvature sensed, the calibrated spectral data, or a combination thereof by comparing against a database of curvatures, spectral signatures, or a combination there of or by using a machine learning model or an inference model.

16. A method for determining one or more properties of an object, the method comprising:
transporting a light signal through at least a portion of a gripping element configured to bend with respect to an axis;
sensing a curvature or a change in curvature of the gripping element with respect to the axis based on the light signal transported;
illuminating the object;
collecting reflected light from the object;
generating spectral data based on the reflected light collected and calibrating the spectral data generated based on the curvature or change in curvature with respect to the axis sensed; and
determining the one or more properties of the object based on the calibrated spectral data, the curvature sensed, or a combination thereof.

17. The method of claim 16, wherein transporting the light signal through at least a portion of a gripping element changes a characteristic of the light signal transported based on a state of the gripping element.

18. The method of claim 16, wherein determining the one or more properties of the object based on the calibrated spectral data, the curvature sensed, or a combination thereof includes using a machine learning model or an inference model.

19. The method of claim 16, further comprising acquiring a set of reference properties for the object through use of the gripping element and storing the set of reference properties acquired, wherein acquiring the set of reference properties includes acquiring reference properties over a substantially full range of bending with respect to the axis of the gripping element through use of objects of a similar type over a range of sizes, the method still further comprising grading additional objects of a similar type to the object through use of the gripping element based on the reference properties stored.

20. (canceled)

21. A system for determining one or properties of an object, the system comprising:
means for sensing a curvature or change in curvature of a gripping element configured to bend along at least one direction with respect to an axis based on a change in a property of a light signal, the light signal transported through at least a portion of the gripping element;
means for generating spectral data of the object based on light reflected from the object, the light reflected coming from a known source, and for calibrating the spectral data generated based on the curvature or change in curvature sensed;
means for determining one or more properties of the object based on the curvature or change in curvature sensed, the calibrated spectral data, or a combination thereof.

22. (canceled)

23. (canceled)
